(19) United States
(12) Patent Application Publication
(10) Pub. No.: US 2012/0067922 A1
(43) Pub. Date: Mar. 22, 2012

(54) CLOSURE

(75) Inventor: Claude Benoit-Gonin, Odenas (FR)

(73) Assignee: OBRIST CLOSURES SWITZERLAND GMBH, Reinach (CH)

(21) Appl. No.: 13/251,581

(22) Filed: Oct. 3, 2011

Related U.S. Application Data
(63) Continuation of application No. PCT/GB2010/000388, filed on Mar. 3, 2010.

(30) Foreign Application Priority Data
Apr. 2, 2009 (GB) 0905749.8

(51) Int. Cl. B67D 7/06; B65D 47/00; B65D 35/38

(52) U.S. Cl. 222/153.06; 222/494; 222/546; 222/556

(57) ABSTRACT

A closure comprises a base and a lid. The base comprises a spout portion. The lid comprises a cover portion and a ring portion securable around the spout portion. The cover portion of the lid is hingedly connected to the ring portion and is moveable between a closed position and an open position, in which the spout portion is substantially unobstructed by the cover portion.

The ring portion and the spout portion comprise locking means, operable to prevent separation of the ring portion from the spout portion.

### FIELD OF THE INVENTION

The present invention relates to a closure for a fluid container. More particularly, the present invention relates to a two-part spout closure for a fluid container.

### BACKGROUND OF THE INVENTION

Several types of closures for resealably closing a fluid container are known, including, for example, provision of a removable screw cap, provision of a spout having a moveable cylindrical valve secured therein, and provision of a flip-top lid or cap.

Known closures, depending on the type, may be easily detached from the fluid container or lost, may require two hands to operate, or require squeezing of the bottle to operate successfully.

It is an object of the present invention to provide an alternative closure for a fluid container.

### SUMMARY OF THE INVENTION

Accordingly, a first aspect of the present invention provides a closure comprising a base and a lid, the base comprising a spout portion, the lid comprising a cover portion and a ring portion fixable to the spout portion, the cover portion of the lid being hingedly connected to the ring portion and moveable between: a closed position; and an open position, in which the spout portion is substantially unobstructed by the cover portion, characterised in that the ring portion and the spout portion comprise locking means, operable to prevent separation of the ring portion from the spout portion.

Forming the closure from two, initially separate, parts allows for different material choices for each of the base and lid parts. It may, for example, be advantageous for the lid part to have different material properties to the base part. The lid part may, for example, advantageously be formed from a transparent plastic material, or a plastics material particularly suitable for formation of a hinge. Furthermore, forming a closure from two, initially separate, parts may allow for a complicated closure to be manufactured more easily and efficiently. It may, for example, not be possible to mould a particularly advantageous closure shape as a single unitary piece. Forming the closure from two pieces may allow the advantageous closure shape to be constructed, since each piece may be individually moulded, then assembled.

Construction of a closure from two parts may result in unwanted separation of the two parts when the closure is in use. Inclusion of locking means, operable to prevent separation of the ring portion from the spout portion mitigates likelihood of such an occurrence.

The locking means may comprise cooperating formations in a longitudinal ratchet arrangement, operable to move past each other in a first direction and resist movement past each other in a second direction.

Inclusion of cooperating formations in a longitudinal ratchet arrangement allows for ease of initial assembly and substantially resists disassembly, thereby mitigating the possibility of separation of the two parts in use. Separation of the parts may be disadvantageous for a variety of reasons, for example, environmental pollution or risk if choking on a part.

The second direction may be substantially opposite the first direction.

The longitudinal ratchet arrangement may be substantially irreversible. That is to say, once the cooperating formations have moved past each other in the first direction, it may be substantially impossible to reverse the action, ie to move the formations back past each other in the second direction.

The dimensions of the cooperating formations may be such that the ratchet arrangement is substantially irreversible. The overlap of the cooperating formations may provide sufficient resistance to movement in the second direction. The cooperating formations may include interlocking elements to resist movement in the second direction.

The locking means may comprise a projection on one or both of the ring or spout portions. The locking means may comprise a projection and a groove. The cooperating portions may comprise a hook and lip. The cooperating formations may comprise a hook and an undercut. The locking means may comprise an undercut on the spout portion.

The hook may form part of the ring portion and the lip may form part of the spout portion. Alternatively, the hook may form part of the spout portion and the lip may form part of the ring portion. One or both of the cooperating formations may include a chamfered surface or inclined flange. The chamfered surface or inclined flange of the formation on the ring or spout portion may be adjacent the formation on the other of the ring or spout portion. Adjacent surfaces of the projections may include chamfered portions.

Chamfering or sloping a surface of one or both cooperating formations may assist initial movement of the cooperating formations past each other.

The cover portion may substantially enclose the spout portion of the base when in the closed position.

The cover portion may include a friction element, operable to assist a user opening the closure. The friction element may comprise a protruding flange. The protruding flange may allow a user to more efficiently exert force on the cover portion thereby to open the closure. The friction portion may comprise one or more ribs or grooves. The ribs or grooves may be moulded into the cover portion.

The spout portion may further comprise a valve. The valve may be a self closing valve. The valve may be integrally formed with the spout portion or formed separately and attachable thereto.

The base may further comprise fastening means for securing the closure to a container. The fastening means may comprise a screw thread for cooperation with a corresponding screw thread located on a container. The fastening means may comprise a groove or projection suitable for “snap fit” engagement with a corresponding formation provided on a container neck.

The cover portion may further include a sealing element, engageable with the spout portion, operable to substantially seal the spout portion. The sealing element may comprise a downwardly extending projection located on the inner surface of the cover portion. The downwardly extending portion may be substantially cylindrical. The sealing element may be received by a rim of the spout portion. The sealing element may be dimensioned such that it is operable to engage within a dispensing orifice provided in the spout portion.

The spout portion may further comprise a self closing valve. The cover portion may include a spigot for sealing the spout portion. The spigot may be operable to seal the self closing valve.

The lid may further comprise a tamper evident member. The tamper evident member may be visible prior to first opening of the closure and may, upon first opening, become at least partly hidden from view. The tamper evident member may be located on the cover portion and the ring portion may at least partly define a void. The tamper evident member may move at least partly into the void in the ring portion upon first opening of the closure. The ring portion may comprise an inner and an outer ring, joined by a top deck, the void may be formed between the inner and outer ring. The topdeck may include an orifice substantially aligned with the tamper evident member.

The tamper evident member may be frangibly connected to the cover portion and said frangible connections may be breakable upon first opening of the closure.

The cover portion and ring portion may be hingedly connected by a double hinge means.

The dual hinge means may comprise a first hinge and a second hinge connecting said cover portion to the ring portion, said cover portion being rotatable with respect to said ring portion about said first and second hinges between the open and closed positions.

One of the first and second hinges may comprise a flexible web. Said cover portion may be rotatable with respect to said ring portion about said double hinge means in excess of approximately 180 degrees between the open and closed positions.

Provision of a double hinge may allow rotation of the cover portion to a position in which the spout portion is substantially unobstructed. In the instance where the closure is placed on a bottle containing a liquid likely to be drunk directly from the bottle, provision of a double hinge may allow rotation of the cover portion to a position in which a user's mouth is unobstructed.

In a second aspect, the present invention further provides a method of forming a closure comprising the steps of: providing a base and a lid, the base comprising a spout portion, the lid comprising a cover portion and a ring portion; fixing the ring portion to the spout portion, the cover portion of the lid being hingedly connected to the ring portion and moveable between: a closed position and an open position, in which the spout portion is substantially unobstructed by the cover portion; providing the ring portion and the spout portion with locking means, operable to prevent separation of the ring portion from the spout portion.

In a third aspect, the present invention provides a method of forming a closure according to the first aspect of the invention, the method comprising the steps of: moulding the base and moulding the lid, the lid being moulded such that the cover portion and ring portion are in an open configuration, assembling the lid on the base, by fixing the ring portion around the spout portion, and moving the cover portion and ring portion to a closed configuration.

Features of each of the various aspects described above may be combined with any one or more of the other aspects.

Further particular and preferred aspects of the present invention are set out in the accompanying independent and dependent claims. Features of the dependent claims may be combined with the features of the independent claims as appropriate, and in combinations other than those explicitly set out in the claims.

### BRIEF DESCRIPTION OF THE DRAWINGS

Embodiments of the present invention will now be described, with reference to the accompanying drawings, in which:

FIG. 1 is a perspective view of a first embodiment in an initial closed position;

FIG. 2 is a perspective view of the embodiment of FIG. 1 after a first opening event;

FIG. 3 is a cross-sectional view of the embodiment of FIG. 1 in the initial closed position; and

FIG. 4 is an enlarged cross-sectional view of a portion of the embodiment of FIG. 1 after the first opening event.

### DESCRIPTION OF THE EMBODIMENTS

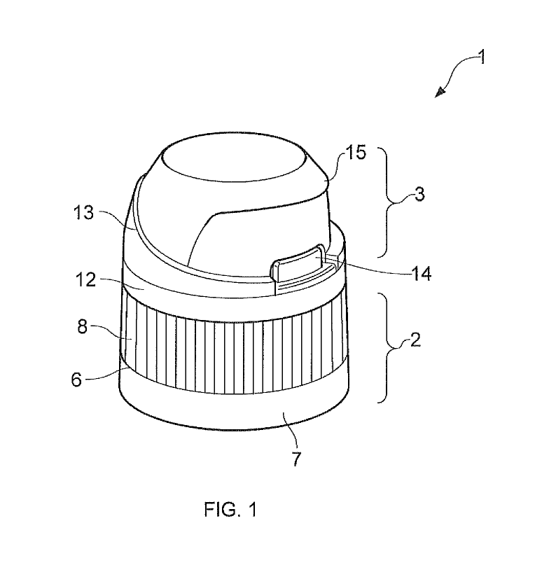

FIG. 1 is a perspective view of a first embodiment of a closure 1 in an initial closed position. The closure 1 comprises a base 2 and a lid 3.

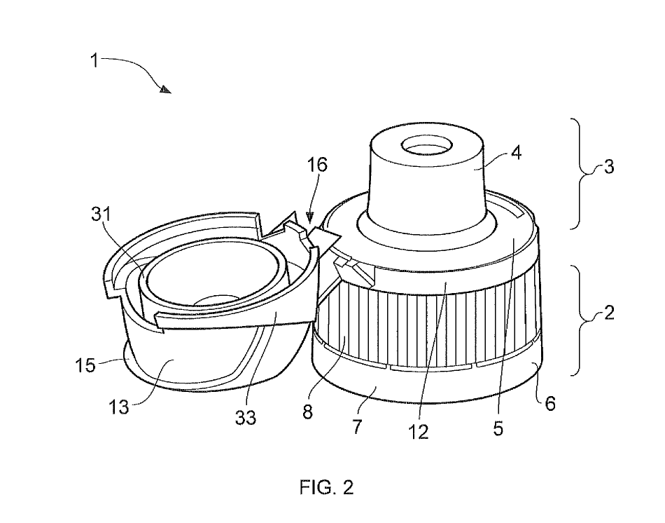

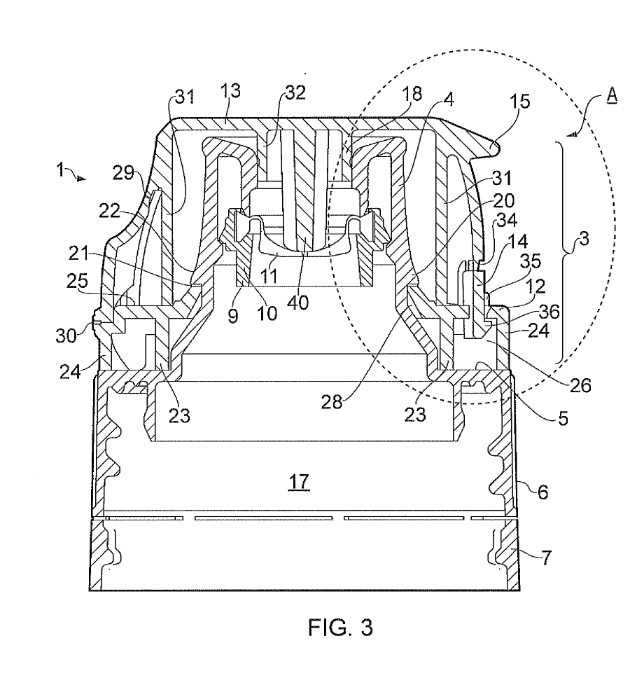

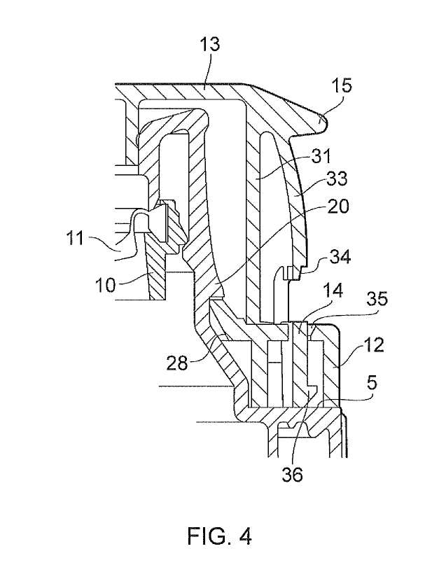

The base 2 has a spout portion 4 located on an upper deck 5 and a skirt 6 depending from the upper deck 5 (shown in FIG. 2). The skirt 6 includes a tamper evident ring 7 and a gripping portion 8. The tamper evident ring 7 is connected to the main skirt 6 by a series of frangible bridges. The gripping portion 8 comprises a series of ribs, formed on the outer surface of the skirt 6. In the illustrated embodiment, the spout portion 4 of the base 2 includes a valve insert 9, which will be described in more detail in relation to FIGS. 3 and 4.

The lid 3 comprises a ring portion 12 and a cover portion 13. The ring portion 12 of the lid is located around the spout portion 4 of the base 2. In the closed position shown in FIG. 1, the cover portion 13 is located such that it substantially encloses the spout portion 4 of the base. The lid 3 further comprises a tamper evident element 14 and a friction lip 15. In the embodiment shown, the tamper evident element 14 is frangibly connected to the cover portion 13.

The structure of the closure is shown in more detail in the cross sectional views of FIG. 3 and FIG. 4.

To move the closure from the initial closed position shown in FIG. 1 to the open position shown in FIG. 2, a user exerts sufficient pressure on the friction lip 15 to cause the frangible connection between the cover portion 13 and the tamper evident element 14 to break. The friction lip 15 permits the position of the cover portion to be changed from the closed position to the open position with one hand.

FIG. 2 is a perspective view of the embodiment of FIG. 1 after such a first opening event. A double hinge 16, linking the cover portion 13 of the lid to the ring portion 12 allows the cover portion to be rotated through approximately 180 degrees from the closed position shown in FIG. 1. A range of rotation of approximately 180 degrees helps to ensure a user's mouth is substantially unobstructed by the cover portion 13 when using the spout portion 4. The ring portion is securely retained around the spout portion 4 whilst the cover portion is moved to the open position by a user.

FIG. 3 is a cross-sectional view of the embodiment of FIG. 1 in the initial closed position. The detailed structure of the base and lid can be more clearly seen.

The base 2 includes a skirt 6 which defines a central orifice 17. The orifice 17 extends from the skirt 6 to an aperture 18 in the spout portion 4. Aperture 18 allows the exit of fluid from a bottle or other container, onto which closure 1 is attached. In the embodiment shown, aperture 18 includes a valve insert 9 formed from a valves support ring 10 and self closing valve 11.

Skirt 6 includes internal threads 19 for mating with corresponding external threads provided on a bottle or other container onto which closure 1 is to be attached.

Spout portion 4 is dimensioned such that it can be at least partially inserted into the mouth of an end user. The end of the spout portion 4 adjacent the upper deck 5 of the base is substantially frustoconical. The end of the spout portion 4 furthest from the deck 5 is substantially cylindrical. In the transition region, the outer surface of the spout portion includes a substantially annular lip 20. The lip 20 extends around the spout portion and, together with the frustoconical base of the spout portion defines an undercut with associated cavity 21. The lip 20 has a chamfered, sloping upper surface 22 which transitions gradually to the generally cylindrical upper portion of the spout 4.

The base 2 may be moulded as a single piece, excluding the valve insert 9. In order create a sufficient undercut the associated cavity 21, in the embodiment shown a slide demoulding technique is used.

If used, the valve insert may be located in the base after moulding.

The lid 3 comprises a ring portion 12 and a cover portion 13. The ring portion 12 is substantially annular and has an inner wall 23 and an outer wall 24 connected by an upper deck 25. A substantially annular void 26 is created between the inner and outer walls of the ring portion. The ring 12 further comprises a radially inwardly extending projection 27. The projection 27 is substantially annular and hook-shaped in cross section. The projection includes a sloped surface 28. When the ring 12 is correctly assembled with the base, the hook is located in cavity 21, formed by the lip 20 on the spout portion.

When the closure 1 is initially assembled from moulded base piece 2 and lid 3, the ring portion 12 of the lid is placed around the spout 4 of the base. Adjacent sloped surfaces 22, 28 of the lip and hook facilitate movement of the hook past the lip in a first direction. Once the hook passes the lip it is accommodated in the cavity 21 formed by the undercut. Attempts to remove the ring from the spout are then significantly hindered by the interaction of the hook 27 with the lip 20. Those cooperating formations are thus understood to be in a longitudinal ratchet arrangement, operable to move past each other in a first direction and resist movement past each other in a second direction.

The cover portion 13 is integrally formed, by moulding, with the ring portion. They are moulded in an open position and connected by a double hinge 16. The double hinge comprises two living hinges 29, 30. The axis of the hinges 29, 30 is generally tangential to the surface of the body 2 and lid 3. The combination of two hinges allows the cover portion 13 to be rotated from a closed position where the cover 13 substantially surrounds the spout portion 4, to an open position where the spout 4 is exposed. The cover is free to rotate such that a user may drink from the spout 4 without interference from the cover portion. That is to say, the cover portion may be rotated through a total of approximately 180 degrees from the closed position, and may be rotated further if necessary.

The cover 13 of the illustrated embodiment includes an inner cap 31 which is substantially cylindrical, depends from the upper surface of the cover, and surrounds the spout portion when the cover is in the closed position. The distal end of the inner cap abuts the ring portion when the cover is in the closed position.

The cover also includes a sealing plug 32, located on the inner surface of the cover and adapted by size and configuration to mate with the aperture 18 in the spout portion of the base. When the closure 1 is in the closed position, the sealing plug 32 is received by the aperture 18. The friction fit between the plug 32 and the walls of aperture 18 provides a fluid tight seal, thereby assisting prevention of any leakage or spillage of fluid through aperture 18.

The cover further includes a spigot 40, which acts to restrict movement of the self closing valve and thereby assists sealing.

An outer cap 33 is also moulded as part of the cover. The tamper evident element 14 forms part of the outer cap 33 and is connected thereto by frangible bridges 34. When the closure 1 is initially assembled, the tamper evident tab 14 is positioned in register with a slot 35 in the upper deck 25 of the ring portion. A hook 36 provided at the distal end of the tamper evident tab 14 enters the slot when the closure 1 is first closed.

In order to open the closure, the cover is hinged away from the ring portion 12. When the cover is moved, frangible bridges 34 are broken. The tamper evident element 14 is released into void 26 beneath slot 35, as shown in FIG. 4. When the cover 13 is returned to a closed position the tamper evident element 14 is no longer visible. The tab 14 is hidden in void 26, and thereby provides visual evidence that the closure 1 has already been opened.

FIG. 4 is an enlarged cross-sectional view portion A indicated in FIG. 3, after first opening of the closure 1.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A flip-top dispensing closure comprising a base and a lid, and a dispensing spout provided on or by the base, the lid comprising a cap and a fixing ring, the cap is hingedly connected to the ring so as to be moveable between a closed and open position, wherein the ring and the spout comprise locking means for securing the lid to the base and in that the ring comprises spaced inner and outer walls.

2. The closure according to claim 1, wherein the lid further comprises a tamper evident member visible prior to first opening of the closure and which, upon first opening, becomes at least partly hidden from view.

3. The closure according to claim 2, wherein the tamper evident member is located on the cover portion and the ring portion at least partly defines a void, and wherein the tamper evident member moves at least partly into the void upon first opening of the closure.

4. The closure according to claim 3, wherein the void is formed between the ring inner and outer walls.

5. The closure according to claim 2, wherein the tamper evident member is frangibly connected to the cover portion and said frangible connections are breakable upon first opening of the closure.

6. The closure according to claim 1, wherein the inner and outer walls are joined by a top deck.

7. The closure according to claim 1, wherein the locking means are provided on or by the ring inner wall.

8. The closure according to claim 1, wherein the locking means comprise cooperating formations in a longitudinal ratchet arrangement, operable to move past each other in a first direction and resist movement past each other in a second direction.

9. The closure according to claim 1, wherein the cooperating portions comprise a hook and lip, the hook forming part of the ring portion and the lip forming part of the spout portion.

10. The closure according to claim 1, wherein the locking means comprises an undercut on the spout portion.

11. The closure according to claim 1, wherein the locking means comprises an inclined flange on the ring portion.

12. The closure according to claim 1, wherein the spout portion further comprises a self closing valve.

13. The closure according to claim 1, wherein the cover portion further includes a engageable with the spout portion.

14. The closure according to claim 1, wherein the cover portion and ring portion are hingedly connected by a double hinge means.

15. A flip-top dispensing closure lid which is attachable to a spout, the lid comprising a cover and a fixing ring, the cover being hingedly connected to the ring so as to be movable between a closed and open position, the ring comprises spaced inner and outer walls and the inner wall includes locking means for engaging a spout to securely retain the ring around the spout in use.

16. The closure lid according to claim 15, wherein the inner and outer walls are joined by a top deck.

17. The closure lid according to claim 15, wherein the locking means are provided on or by the ring inner wall.

18. The closure lid according to claim 15, wherein the locking means comprise cooperating formations in a longitudinal ratchet arrangement, operable to move past each other in a first direction and resist movement past each other in a second direction.

19. The closure lid as claimed in claim 1, in which the inner wall locking means comprises a projection.

20. The closure lid as claimed in claim 9, in which the projection is generally annular.

21. The closure lid as claimed in claim 15, in which the lid is formed from a transparent plastics material.

22. The closure lid according to claim 15, wherein the locking means comprises an inclined flange on the ring portion.

23. The closure comprising a flip-top dispensing closure lid according to claim 15 and a base having a spout.

24. The closure according to claim 23, wherein the locking means comprises an undercut on the spout portion.

25. The closure according to claim 23, wherein the cooperating portions comprise a hook and lip, the hook forming part of the ring portion and the lip forming part of a spout.
